(19) United States
(12) Patent Application Publication
(10) Pub. No.: US 2015/0146728 A1
(43) Pub. Date: May 28, 2015

(54) COMMUNICATION PACKET PROCESSING APPARATUS AND METHOD

(71) Applicant: HITACHI, LTD., Tokyo (JP)

(72) Inventor: Yukihiro SHIMMURA, Tokyo (JP)

(21) Appl. No.: 14/530,848

(22) Filed: Nov. 3, 2014

(30) Foreign Application Priority Data
Nov. 28, 2013 (JP) 2013-245577

(51) Int. Cl. H04L 12/741

(52) U.S. Cl. CPC H04L 45/74
USPC 370/392

(57) ABSTRACT

A communication packet processing apparatus and method for absorbing coexistence of different methods of communication packet reception processing is provided by the same software. A communication packet processing apparatus for transmitting and receiving packets possesses a communication interface for transmitting and receiving packets and a first table storing correspondent information of the communication interface. The correspondent information includes a method of communication packet reception processing that the communication interface can correspond to. The method of communication packet reception processing includes a first method and a second method. The communication interface operates under one or both of the first method and the second method. The communication packet processing apparatus refers to the first table when starting up, and if the first method is designated, confirms whether the communication interface corresponds to the first method, and then if the result is affirmative, operates under the first method.

### CROSS-REFERENCE TO RELATED APPLICATION

This application claims the Japanese Patent Application No. 2013-245577 filed Nov. 28, 2013, which is incorporated herein by reference in its entirety.

### BACKGROUND

The present invention relates to communication packet processing. More particularly, the present invention relates to switching technology of communication packet reception method in a communication packet processing apparatus.

An apparatus which processes communication packet generally performs processing of the packet by software so as to correspond to the diversity of the processing thereof. The communication packet reception processing by software is implemented by mainly two software processing sections. One is a software processing section to control hardware at which communication packet arrives (hereinafter abbreviated as “software processing section A”), and the other is a software processing section to receive the arrived packet from the hardware (hereinafter abbreviated as “software processing section B”).

There are two methods of receiving the communication packet in the software processing section B, which are a conventional method and a method come to be used recently.

The former method is that, when a communication packet arrives at the hardware, the software processing section A notifies the software processing section B of the arrival and thereby the software processing section B performs the reception processing. It is a widely used method. This is described as an interrupt notification system. The interrupt notification system is called a socket method because a socket interface is used under this system.

However, in order to improve efficiency of the communication packet reception processing due to the progress of the communication speed, a method comes to be used recently in which the software processing section A does not notify the software processing section B even if a packet arrives at the hardware. This method is described as a polling system, since it monitors an arrival of the packet at the hardware by polling. The polling system makes it possible to perform faster communication packet reception processing than the interrupt notification system, because there is no need to issue and receive the notification.

Besides, as a background art which relates to the technical field of the present invention, there is a technology described in Japanese Unexamined Patent Application Publication No. 2012-120085. Japanese Unexamined Patent Application Publication No. 2012-120085 describes a technology which implements a network relay apparatus with low electric power consumption due to switching between software and hardware, which transfers processing of a packet.

### SUMMARY

There are two methods of receiving the communication packet in the communication packet processing apparatus as described above, which are the interrupt notification system and the polling system. It is desirable to use the polling system with high efficiency and capable of fast communication packet reception, in consideration of the further progress of the communication speed in the future. However, the polling system uses a different control method from that of the conventional system, it will take time for hardware products, such as communication interfaces corresponding only to the interrupt notification system, to shift to the new products corresponding also to the polling system. In short, hereafter, concerning the communication packet reception method in the communication packet processing apparatus, there coexist the interrupt notification system and the polling system. As described above, since these two systems are different in methods for controlling hardware, it is necessary to manufacture dedicated software respectively corresponding to each system, which is inefficient.

Japanese Unexamined Patent Application Publication No. 2012-120085 only discloses the method for switching between software and hardware, which transfers processing of a packet, which enables to make transfer processing effective. It does not consider dealing with different communication packet reception methods by the same software.

The present invention is made in order to solve the aforementioned problem, and an object of the present invention is to absorb coexistence of different communication packet reception methods by the same software.

In order to solve the above problem, according to one aspect of the present invention, a communication packet processing apparatus includes a communication interface for transmitting and receiving communication packets, a communication interface control section for controlling the communication interface, a communication packet control section for controlling transmission and reception of the packets, a first table storing hardware information and correspondent information of the communication interface, wherein the correspondent information includes a method of communication packet reception processing that the communication interface can correspond to, and a parameter designating the method of communication packet reception processing to be performed by the communication packet processing apparatus. The method of communication packet reception processing includes a first method and a second method. The communication interface operates under one or both of the first method and the second method. The communication packet processing apparatus, when starting up, refers to the parameter and if the first method is designated, confirms whether the communication interface corresponds to the first method. Then, if the result is affirmative, the communication packet processing apparatus controls to enable the operation of the communication interface control section and the communication packet control section under the first method.

Moreover, according to another aspect of the present invention, a communication packet processing method for transmitting and receiving communication packets in a communication packet processing apparatus is disclosed. The communication packet processing apparatus possesses a communication interface for transmitting and receiving communication packets and a first table storing correspondent information of the communication interface, wherein the correspondent information includes a method of communication packet reception processing that the communication interface can correspond to. The method of communication packet reception processing includes a first method and a second method. The communication interface operates under one or both of the first method and the second method. Here, the communication packet processing method includes referring to the first table if the first method is designated when starting up the communication packet processing apparatus to confirm whether the communication interface corresponds to the first method, and if the result is affirmative, operating under the first method.

According to the present invention, it is made possible to absorb coexistence of the different communication packet reception methods by the same software, and it becomes unnecessary to manufacture dedicated software respectively corresponding to each of the interrupt notification system and the polling system.

### BRIEF DESCRIPTION OF THE DRAWINGS

FIG. 1 shows an example of hardware configuration of a communication packet processing apparatus according to one embodiment of the present invention;

FIG. 2 shows an example of software configuration of a communication packet processing apparatus according to one embodiment of the present invention;

FIG. 3 shows a flowchart illustrating an example of starting processing of a communication packet processing apparatus according to one embodiment of the present invention;

FIG. 4 shows a flowchart illustrating determination processing of communication packet reception method according to one embodiment of the present invention;

FIG. 5 shows a configuration parameter according to one embodiment of the present invention;

FIG. 6 shows a flowchart illustrating NIC correspondence confirmation processing according to one embodiment of the present invention;

FIG. 7 shows a polling-correspondent NIC table according to one embodiment of the present invention;

FIG. 8 shows an IF information management table according to one embodiment of the present invention;

FIG. 9 shows an example of communication packet reception processing under a polling system by the application;

FIG. 10 shows an example of communication packet reception processing under a polling system in an OS;

FIG. 11 shows communication packet reception processing under the interrupt notification system;

FIG. 12 shows a hardware configuration of communication packet processing apparatus according to one embodiment of the present invention; and

FIG. 13 shows an example of a flowchart regarding communication interface switch processing for redundancy.

### DETAILED DESCRIPTION

Embodiments of the present invention will be described hereinafter with reference to the drawings.

### First Embodiment

In this embodiment, an example of a communication packet processing apparatus which has a function for switching methods of communication packet reception processing will be described.

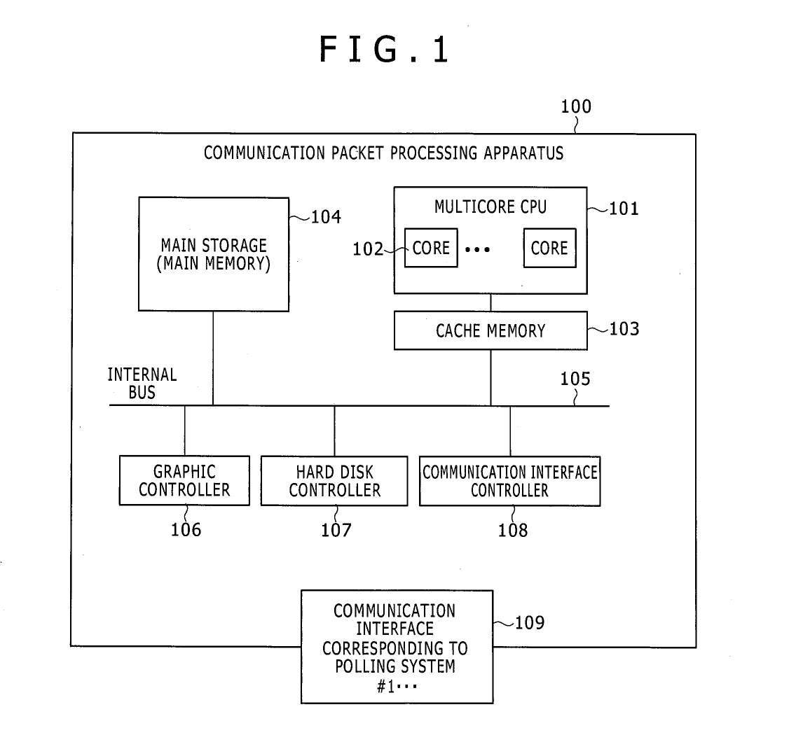

FIG. 1 shows an example of hardware configuration of a communication packet processing apparatus according to one embodiment of the present invention.

A communication packet processing apparatus 100 is provided with plural communication interfaces (NIC: Network Interface Card) 109, including one or more communication interfaces which correspond to a communication packet reception method of the polling system. Moreover, a CPU (Central Processing Unit) 101, a cache memory 103, a main storage (main memory) 104, a graphic controller 106, a hard disk controller 107, and a communication interface controller 108 are connected mutually via an internal bus 105, in the communication packet processing apparatus. Further, a communication interface controller 108 is a hardware device which plays a role in controlling the communication interfaces 109. Besides, among the communication interfaces 109, those described above which correspond to the polling system are premised on capability of operation under the interrupt notification system as well.

The CPU 101 may be a single core CPU with one core 102 or a multicore CPU with more than one core 102. Moreover, it may be a multiprocessor with more than one CPU 101. Furthermore, the cache memory 103 may exist within CPU 101 in addition to the cache memory 103 attached to the CPU 101.

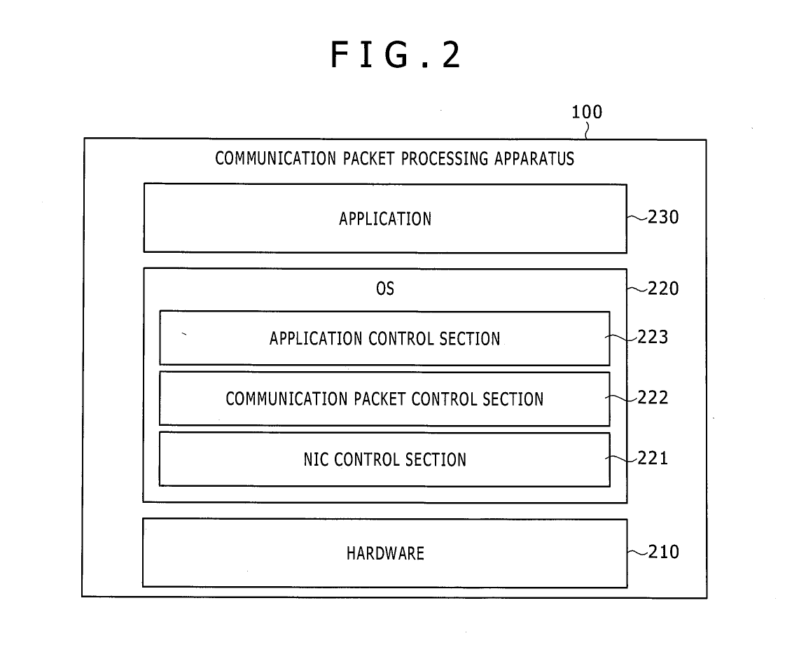

FIG. 2 shows an example of software configuration of a communication packet processing apparatus according to one embodiment of the present invention.

Software of the communication packet processing apparatus includes an OS (operating system) 220 operating on hardware 210 and an application 230.

The application 230 is the software which is the origin of processing for switching method of communication packet reception processing described in this embodiment.

The OS 220 is composed of a NIC control section 221, a communication packet control section 222, and an application control section 223. The NIC control section 221 is a control section which controls the communication interface 109 via the communication interface controller 108, and exists for respective communication packet reception method concerning each communication interface controller 108. Accordingly, the NIC control section 221, appropriately corresponding to the communication interface controller 108 and the communication packet reception method to be used, will be selected properly and used.

The communication packet control section 222 performs communication packet reception processing from the NIC control section 221, and communication packet transmission processing to the NIC control section 221. Additionally, it performs processing to pass a received packet to the application 230 and processing to receive a packet to be transmitted from the application. Besides, it has an elementary communication protocol stack, such as IP protocol stack or Ethernet protocol stack, which enables to perform communication protocol processing of a communication packet, when transmitting and receiving it.

The application control section 223 performs an elementary control to operate the application 230. The elementary control represents processing to allocate hardware resource such as a memory space or a CPU time for the application 230 to operate, processing to start the application 230, etc.

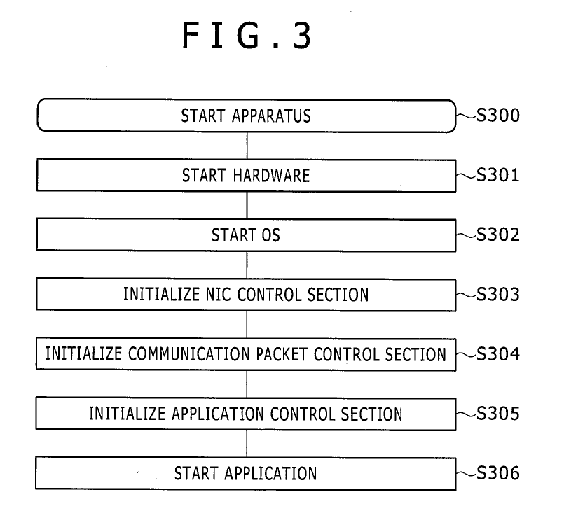

FIG. 3 shows a flowchart illustrating an example of start processing of a communication packet processing apparatus according to one embodiment of the present invention.

In start processing of a communication packet processing apparatus, hardware starts (S301) first after a step of apparatus startup (S300), then the OS 220 starts (S302). In the step of OS start processing (S302), initialization of the NIC control section (S303), initialization of the communication packet control section (S304), and initialization of the application control section (S305) are performed. In particular, in the step of initialization of the NIC control section (S303), the OS 220 recognizes all of the communication interfaces 109 possessed by the communication packet processing apparatus 100, and acquires the hardware OS information of the interfaces. Then, it holds such information in the OS 220. The hardware information that the OS 220 holds includes information which can specify the communication interface 109, such as vendor ID and device ID. Subsequently, the OS 220 selects the NIC control section 221 corresponding to the interrupt notification system of each communication interface 109, and performs initial setting of the communication interfaces 109 via the communication interface controller 108 so as to enable transmission and reception of the communication packet.

After completion of OS startup (S302), the OS 220 performs startup of the application (S306).

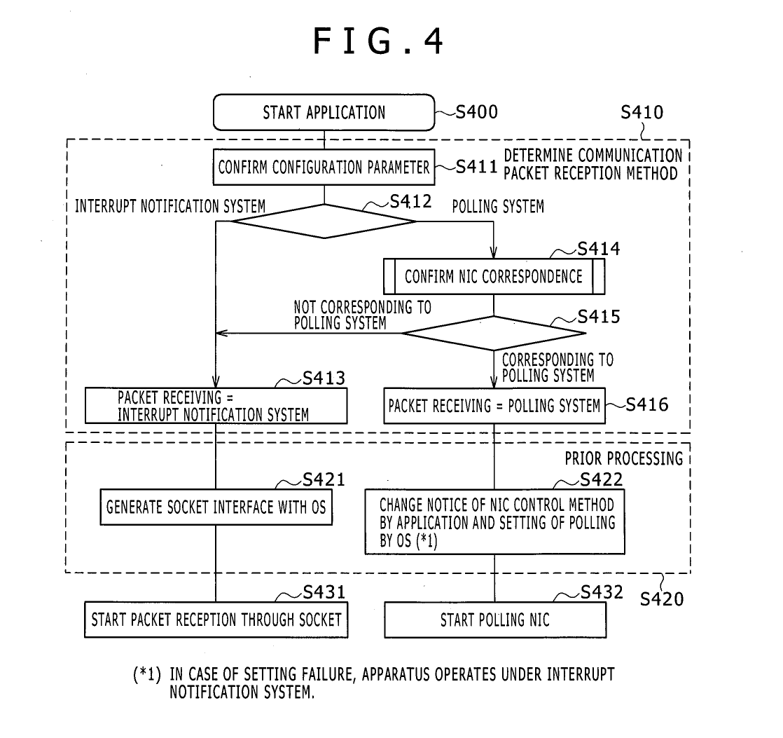

FIG. 4 shows a flowchart illustrating determination processing of communication packet reception method according to one embodiment of the present invention.

When the application 230 is started by the OS 220 (S306), the communication packet reception method is determined by the application (S410). In the determination processing (S410) of the packet reception method, the configuration parameter is confirmed firstly (S411). In this embodiment, the configuration parameter has a function of identifying the communication packet reception method, which is supposed to be prepared as a configuration file in advance.

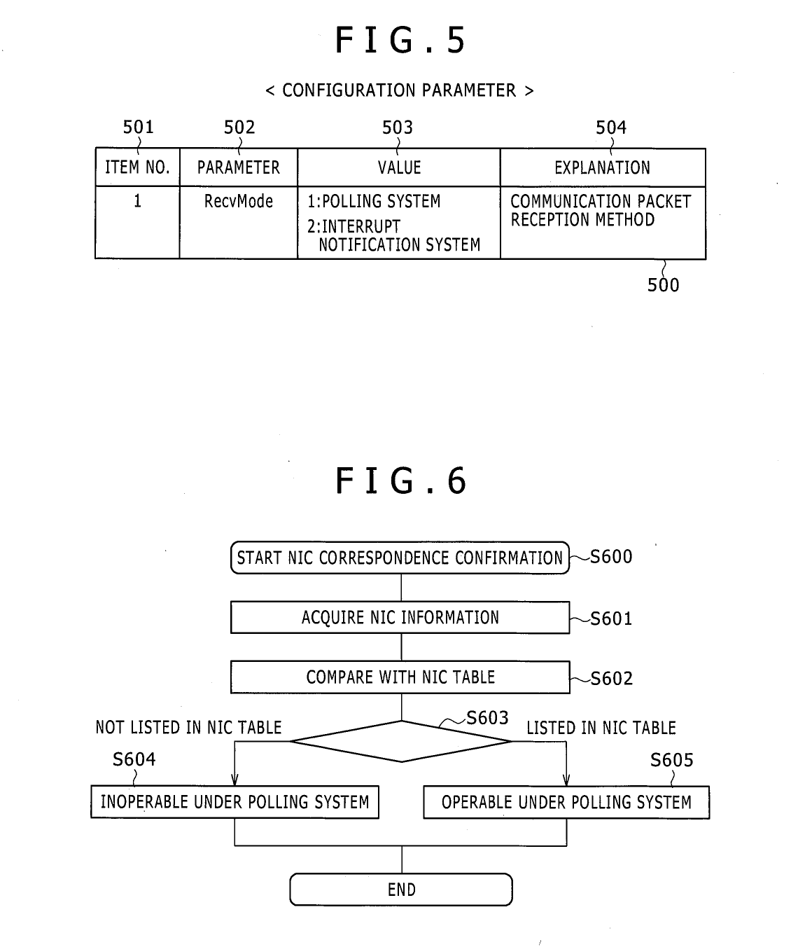

FIG. 5 shows a configuration parameter according to one embodiment of the present invention. The configuration parameter 500 includes item No. 501, parameter 502, value 503, and explanation 504, according to an example shown in FIG. 5. The communication packet reception method can be set up by changing the value 503 of the configuration parameter 500 by a maintenance person.

In case that the interrupt notification system is specified in the configuration parameter 500, the application 230 determines the communication packet reception method as the interrupt notification system (S413).

On the other hand, if the polling system is specified in the configuration parameter 500, the application 230 performs a step of NIC correspondence confirmation (S414) in order to confirm whether operation is possible under the polling system. The details of the NIC correspondence confirmation (S414) will be described later with reference to FIG. 6. As a result of the NIC correspondence confirmation (S414), if operation is possible under the polling system, the communication packet reception method is determined as the polling system (S416). As a result of the NIC correspondence confirmation (S414), if operation is not possible under the polling system, the communication packet reception method is determined as the interrupt notification system (S413).

FIG. 6 shows a flowchart illustrating the NIC correspondence confirmation processing according to one embodiment of the present invention.

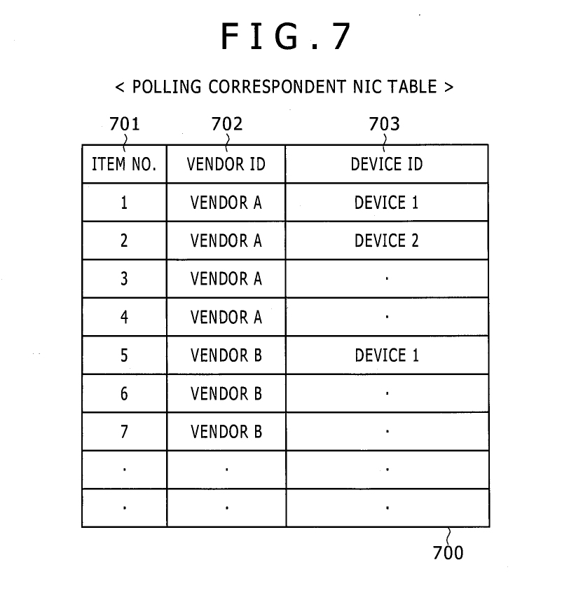

In the NIC correspondence confirmation, the application 230 acquires firstly, from the OS 220, the hardware information of the communication interfaces 109 which is possessed by the communication packet processing apparatus 100 (S601). The hardware information includes vendor ID and device ID which can specify hardware according to this embodiment. Next, the application 230 compares a combination of vendor ID and device ID acquired with a polling-correspondent NIC table shown in FIG. 7 (S602).

FIG. 7 shows a polling-correspondent NIC table according to one embodiment of the present invention.

The polling-correspondent NIC table 700 includes item No. 701, vendor ID 702, and device ID 703. It is information which can specify a communication interface capable of operating under the polling system. Vendor ID 702 is a vendor-specific identifier which can specify a production vender of the communication interface 109. Moreover, Device ID 703 is a hardware-specific identifier which can specify hardware itself among those of the same vendor. Namely, whether or not the polling-correspondent NIC table contains a combination of vendor ID and device ID of a communication interface 109, can uniquely specifies whether or not communication interface 109 is able to operate under the polling system. The polling-correspondent NIC table 700, after grasping the information of the available communication interfaces operable under the polling system in advance, is incorporated into the application 230 during manufacture thereof, or it is prepared as an external file and read into the application 230 during its startup. An advantage of preparing the external file is that, even if a new product of the communication interface is manufactured which corresponds to the polling system, it can be handled by just adding the hardware information of the new communication interface to the external file, so that it becomes unnecessary to remanufacture the software. Furthermore, preparing the external file enables the correspondence to even the extension of communication interface.

Returning to FIG. 6, the application 230 compares the hardware information (a combination of vendor ID and device ID) of the communication interface 109, acquired by the application 230 (S601), with the polling-correspondent NIC table 700 shown in FIG. 7 (S602). As a result, if the NIC concerned is listed in the polling-correspondent NIC table 700, the application recognizes the NIC as the communication interface operable under the polling system (S605).

On the other hand, if the NIC concerned is not listed in the polling-correspondent NIC table 700, the application recognizes the NIC as the communication interface inoperable under the polling system (S604). Above comparison is made with respect to every communication interface 109, possessed by the communication packet processing apparatus 100.

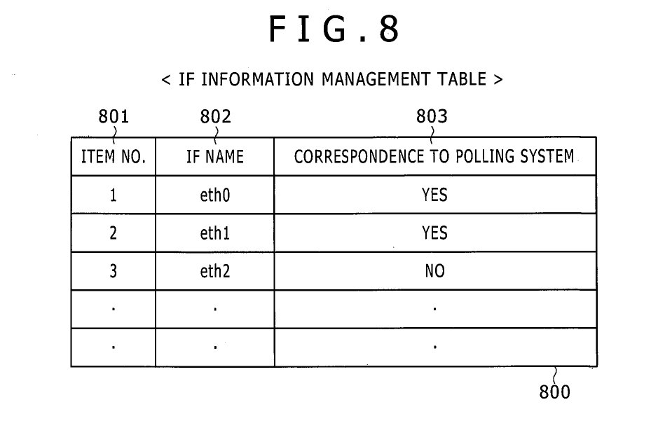

The result of the above comparison regarding every communication interface 109 is registered and held in an IF information management table 800 shown in FIG. 8.

FIG. 8 shows the IF information management table according to one embodiment of the present invention.

The IF information management table is composed of item No. 801, IF (Interface) name 802, and polling correspondence 803. It is a table which manages polling correspondence of each communication interface 109, possessed by the communication packet processing apparatus 100. The IF name 802 represents the name of each communication interface 109 possessed by the communication packet processing apparatus 100. Moreover, the polling correspondence 803 is an identifier which shows a situation of correspondence to polling system by the IF name 802, namely whether it corresponds to the polling system or not. The IF information management table 800 represents the information held in the application 230.

Returning to FIG. 4, the application 230 completes registration of all the communication interfaces 109, possessed by the communication packet processing apparatus 100, to the IF information management table 800. Then, it confirms whether the IF information management table 800 contains the communication interface 109 which does not correspond to the polling system (S415). As a result of confirmation, if all of the communication interfaces 109 are operable under the polling system, the application 230 determines the communication packet reception method as the polling system (S416 in FIG. 4).

Besides, an alternative method of confirmation for the above may be performed as follows. That is, information of the communication interface 109 to use the polling system in the communication packet processing apparatus 100 may be prepared as an external configuration file. Thereafter, confirmation may be made whether operation under the polling system is possible regarding only the communication interfaces 109 whose information is contained in the external configuration file. Information of the communication interface 109 to use the polling system indicates the IF name 802 of the corresponding communication interface 109.

After the determination of the communication packet reception method (S410), prior processing is performed (S420). The prior processing is processing for receiving a communication packet by using the communication packet reception method, determined in the determination of the communication packet reception method (S410).

In the determination of the communication packet reception method (S410), when the application 230 determines the method of communication packet reception processing as the interrupt notification system (S413), it generates a socket interface with the OS 220 in order to receive communication packets from the OS 220 which are received thereby (S421). Hereafter, the application is capable of receiving the communication packets by monitoring the socket interface (S431).

In the determination of the communication packet reception method (S410), when the application determines the method as the polling system (S416), it notifies the OS 220 of change of NIC control method (S422). Processing by the OS 220, subsequent to the notification from the application 230, is shown below.

In the initialization of the NIC control section (S303) during the startup of the communication packet processing apparatus 100, the OS 220 selects the NIC control section 221 which corresponds to the interrupt notification system of the communication interface 109. Consequently, when the OS 220 receives the change notification (S422) of NIC control method from the application 230, it removes the NIC control section 221 corresponding to the interrupt notification system and incorporates the NIC control section 221 corresponding to the polling system.

Here, the removal of the NIC control section 221 corresponding to the interrupt notification system represents the removal of processing group, possessed by the current NIC control section, for controlling NIC from registration in the OS. Besides, incorporation of the NIC control section 221 corresponding to the polling system represents registration of processing group, possessed by the current NIC control section, for controlling a NIC in the OS. Accordingly, it represents that the OS 220 enables the corresponding communication interface to be available under the polling system hereafter. The processing group for controlling NIC includes, for example, preparation processing for using hardware, data input processing to the hardware, data output processing to the hardware, configuration change processing to the hardware (switching of hardware optional function, etc.), and end processing for ending use of the hardware, etc.

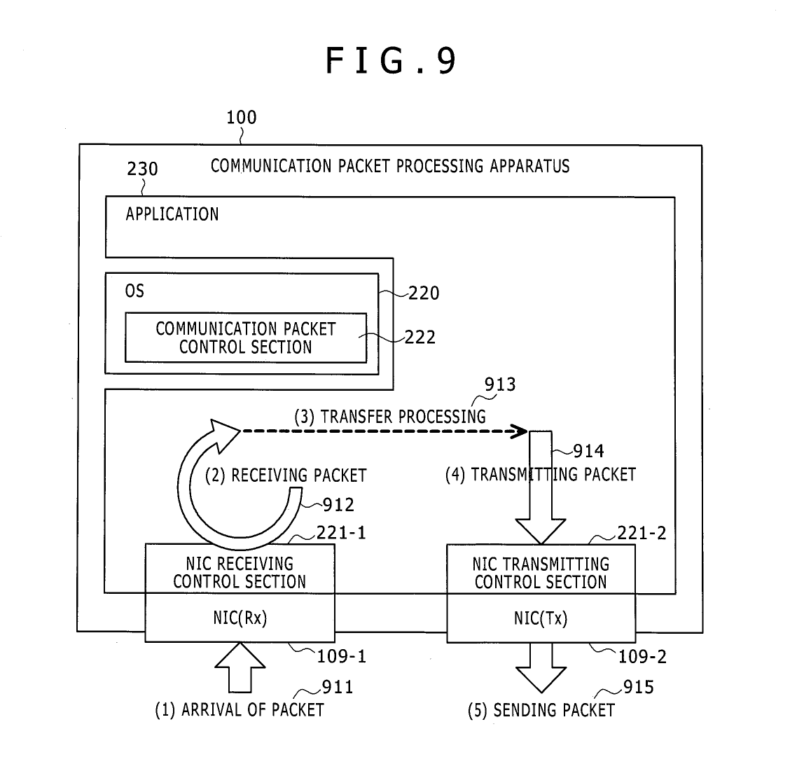

There are following differences between the NIC control section corresponding to the interrupt notification system and the NIC control section corresponding to the polling system. Those differences are content of hardware control of the communication interfaces 109 via the communication interface controller 108, and notification method of packet receipt to the communication packet control section 222 and the application 230. The details will be described later with reference to FIGS. 9, 10, and 11.

After the application 230 notifies OS220 of changing NIC control method (S422) and thereafter the above processing by the OS 220 is completed, then the application 230 or the communication packet control section 222 monitors a receipt of communication packet by the communication interface 109 periodically (polling monitoring) (S432). Accordingly, this makes it possible to receive a communication packet, so that polling monitoring of the NIC will be started. On the other hand, if the above processing by the OS 220 after the notification by the application 230 (S422) does not succeed normally, the OS 220 changes the communication packet reception method from the polling system, which is determined in the step S410, to the interrupt notification system. Next, the OS 220 performs the prior processing (S420) in case of the interrupt notification system, and then receives a communication packet via the socket interface. The above processing prevents the following problem etc., even if there exist defects in a technically new NIC control section 221 corresponding to the polling system. This problem is that the processing of the communication packet does not succeed because the starting of the communication packet processing apparatus 100 fails due to the above defects. The reason is that, as the prior processing S420 in case of the interrupt notification system is conventionally performed, the possibility to fail is considered lower than that in case of the polling system. Consequently, this allows the communication packet processing apparatus 100 to prevent the failure of starting itself.

Hereafter, the processing of the communication packet by the communication packet processing apparatus 100 under each communication packet reception method (polling system and interrupt notification system) will be described with reference to FIGS. 9, 10, and 11.

FIG. 9 shows an example of the communication packet reception processing under the polling system by the application 230.

To begin with, the NIC control section 221 is a section in the OS 220, which may not be accessed directly from the application 230 usually. This is because each memory space is clearly separated between the OS 220 and the application 230. However, in recent years, the technology is disclosed that the NIC control section 221 can be directly accessible from the application 230. This technology enables the application 230 to access the memory space, usually used for the processing in the OS 220. Accordingly, this enables to perform the processing also in the application 230 which is originally performed within the OS 220. Generally, it takes more labor to change the processing performed in the OS 220 than that performed in the application 230. When using this technology, although the OS 220 corresponding to this technology is required, it becomes possible to change, where necessary, the processing in the OS 220 without much labor. Consequently, more flexible access to the hardware maybe implemented by use of this technology. FIG. 9 is described as an example in a case where the application 230 performs a direct access to the NIC control section 221.

The communication packet processing apparatus 100 shown in FIG. 9 is provided with two communication interfaces 109, one of which is used for receiving and the other for transmitting. The NIC receiving control section 221-1 which controls the communication receiving interface 109-1, and the NIC transmitting control section 221-2 which controls the communication transmitting interface 109-2, are both the NIC control sections 221 for the polling system operating under the polling system after the startup of the application (S306 in FIG. 3). Moreover, it performs periodically the communication packet reception processing 912 which receives the communication packet from the communication receiving interface 109-1 provided by the NIC receiving control section 221-1. When the application 230 is about to perform the communication packet reception processing 912, if there exists no communication packet in the communication receiving interface 109-1, it does not perform the communication packet reception processing 912. The NIC receiving control section 221-1 for the polling system does not notify the OS 220 of the interrupt, even if the communication packet arrives at the communication receiving interface 109-1.

Here, the communication receiving interface 109-1, when the communication packet reaches it, holds the received packet. While the communication receiving interface 109-1 holds the communication packet, if the application 230 performs the communication packet reception processing 912, provided by the NIC receiving control section 221-1, this section 221-1 acquires the communication packet held in the communication receiving interface 109-1, and passes it to the application 230.

Then, the application 230 performs transfer processing 913 after receiving the communication packet (912). The transfer processing 913 represents the necessary and peculiar processing for service by the communication packet processing apparatus 100.

The application 230, after the transfer processing 913, performs transmitting processing to the communication transmitting interface 109-2, provided by the NIC transmitting control section 221-2. It thereby performs transmitting processing 914 of the communication packet.

After the receipt of the packet to be transmitted, the communication transmitting interface 109-2 sends the packet (915).

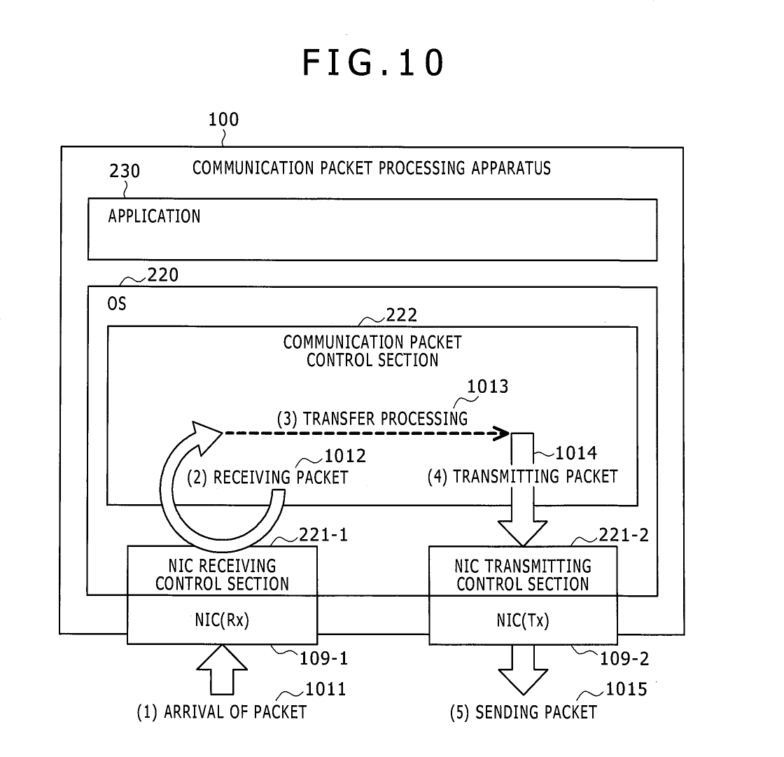

FIG. 10 shows an example of the communication packet reception processing under the polling system performed in the OS.

In FIG. 9, the case is described where the technology is used which is able to access the NIC control section 221 in the OS 220 from the application 230. On the other hand, FIG. 10 illustrates a case to perform the processing of the communication packet within the OS 220, without using the technology described in FIG. 9.

The communication packet processing apparatus 100 shown in FIG. 10 is provided with two communication interfaces 109, one of which is used for receiving and the other for transmitting. The NIC receiving control section 221-1 which controls the communication receiving interface 109-1, and the NIC transmitting control section 221-2 which controls the communication transmitting interface 109-2, are both the NIC control sections 221 for the polling system. The communication packet control section 222 operates under the polling system after the startup of OS (S302 in FIG. 3). Moreover, it performs periodically the communication packet reception processing 1012 which receives the communication packet from the communication receiving interface 109-1, provided by the NIC receiving control section 221-1. When the application 230 is about to perform the communication packet reception processing 1012, if there exists no communication packet in the communication receiving interface 109-1, it does not perform the communication packet reception processing 1012. The NIC receiving control section 221-1 for the polling system does not notify the OS 220 of the interrupt, even if the communication packet arrives at the communication receiving interface 109-1. Here, the communication receiving interface 109-1, when the communication packet reaches it (1011), holds the received packet. While the communication receiving interface 109-1 holds the communication packet, if the communication packet control section 222 performs the communication packet reception processing 1012, provided by the NIC receiving control section 221-1, this section 221-1 acquires the communication packet held in the communication receiving interface 109-1, and passes it to the communication packet control section 222.

Then, the communication packet control section 222 performs transfer processing 1013 after receiving the communication packet (1012). The transfer processing 1013 represents the necessary and peculiar processing for service by the communication packet processing apparatus 100.

The communication packet control section 222, after the transfer processing 1013, performs transmitting processing to the communication transmitting interface 109-2, provided by the NIC transmitting control section 221-2. It thereby performs transmitting processing 1014 of the communication packet. After the receipt of the packet to be transmitted, the communication transmitting interface 109-2 sends the packet (1015).

As described above, FIG. 9 shows an example of the communication packet reception processing under the polling system, performed within the application 230. On the other hand, FIG. 10 shows an example of the communication packet reception processing under the polling system, performed within the OS 220. There may be following two ways of adopting either method of FIG. 9 or FIG. 10. One is to determine either method when manufacturing the communication packet processing apparatus 100, thereafter to manufacture the application 230 and the OS 220, which correspond to the method determined above. The other is to manufacture two sets of the applications 230 and the OS 220, which correspond to each method. Thereafter, either method is designated by a maintenance person e. g., using an external configuration file, during operation of the communication packet processing apparatus 100. Then, the application 230 and the OS 220 will operate under the designated method.

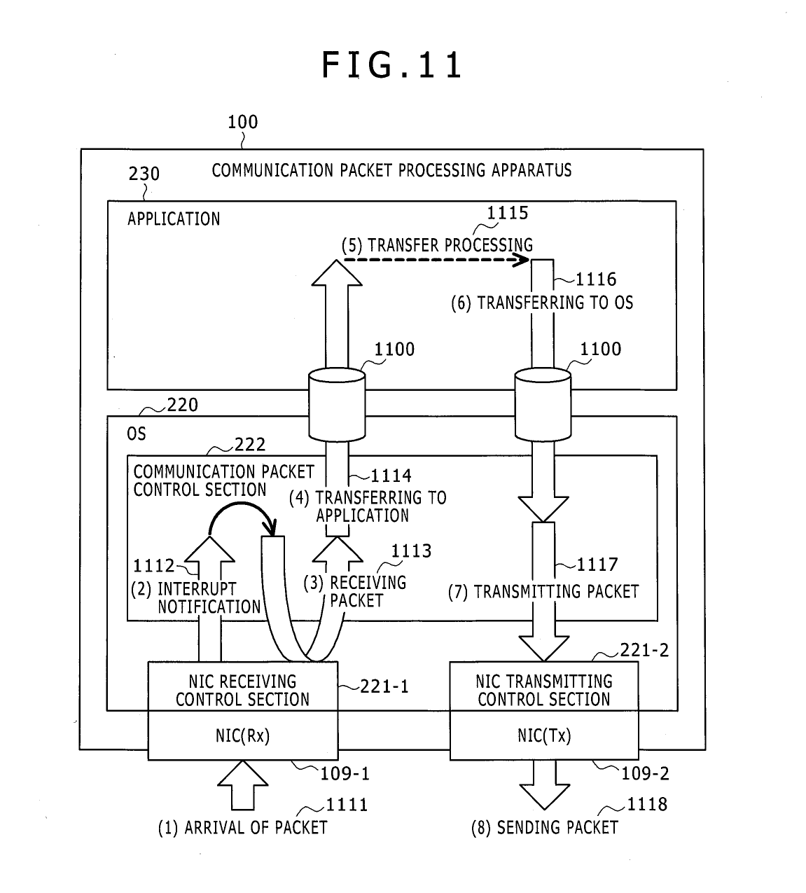

FIG. 11 shows communication packet reception processing under the interrupt notification system.

The communication packet processing apparatus 100 is provided with two communication interfaces 109, one of which is used for receiving and the other for transmitting. The NIC receiving control section 221-1 which controls the communication receiving interface 109-1, and the NIC transmitting control section 221-2 which controls the communication transmitting interface 109-2, are both the NIC control sections 221 for the interrupt notification system. Namely, when the communication packet arrives at the communication receiving interface 109-1, the NIC receiving control section 221-1 notifies the OS 220 of the arrival of the packet by the interrupt notification. The communication packet control section 222 operates under the interrupt notification system after the startup of the OS 220 (S302 in FIG. 3). Normally, it is in a state of waiting for a request for receiving the communication packet from the OS 220. Furthermore, the application 230 is connected to the communication packet control section 222 of the OS 220 through a socket interface 1100. The application 230 monitors the socket interface 1100, in a state of waiting for an arrival of the packet.

When the communication packet arrives (1111) at the communication receiving interface 109-1, it holds the received packet, and notifies the NIC receiving control section 221-1 of the arrival of the packet. The NIC receiving control section 221-1, after notified of the arrival of the packet by the communication receiving interface 109-1, notifies the OS 220 thereof by the interrupt notification (1112). The OS 220, after receiving the interrupt notification from the NIC control receiving section 221-1, requests the communication packet control section 222 to receive the communication packet. Subsequent to the receipt of the request for receiving the communication packet, the communication packet control section 222 acquires the packet, held in the communication receiving interface 109-1, by the communication packet reception processing 1113, which is provided from the NIC receiving control section 221-1. Then, it passes (1114) the received packet to the application 230 through the socket interface 1100.

After receipt of the communication packet through the socket interface 1100, the application 230 performs the transfer processing 1115. The transfer processing 1115 represents the necessary and peculiar processing for service by the communication packet processing apparatus 100.

The application 230, after the transfer processing 1115, requests the OS 220 to transmit the communication packet (1116) through the socket interface 1100.

Following the receipt of the request to transmit the communication packet from the application 230, the OS 220 requests the communication packet control section 222 to transmit the communication packet. Then, the communication packet control section 222 obtains the packet to be transmitted through the socket interface 1100, and performs transmitting processing to the communication transmitting interface 109-2, provided by the NIC transmitting control section 221-2. It thereby performs transmitting processing 1117 of the communication packet.

After the receipt of the packet to be transmitted, the communication transmitting interface 109-2 sends the packet (1118).

From the above, the present invention makes it possible that coexistence of different communication packet reception methods can be absorbed by the same software. In other words, it is enabled to cope with the coexistence of the both systems, the interrupt notification system and the polling system, as follows. Namely, without need for manufacturing respective software to correspond to each system, by discriminating which system to adopt when starting up the software, the communication packet processing apparatus 100 is able to operate by the same software under the appropriate system therefor.

### Second Embodiment

In this embodiment, an example of a communication packet processing apparatus will be described, where communication interfaces corresponding to the polling system and those not corresponding thereto coexist and those communication interfaces can be switched during operation.

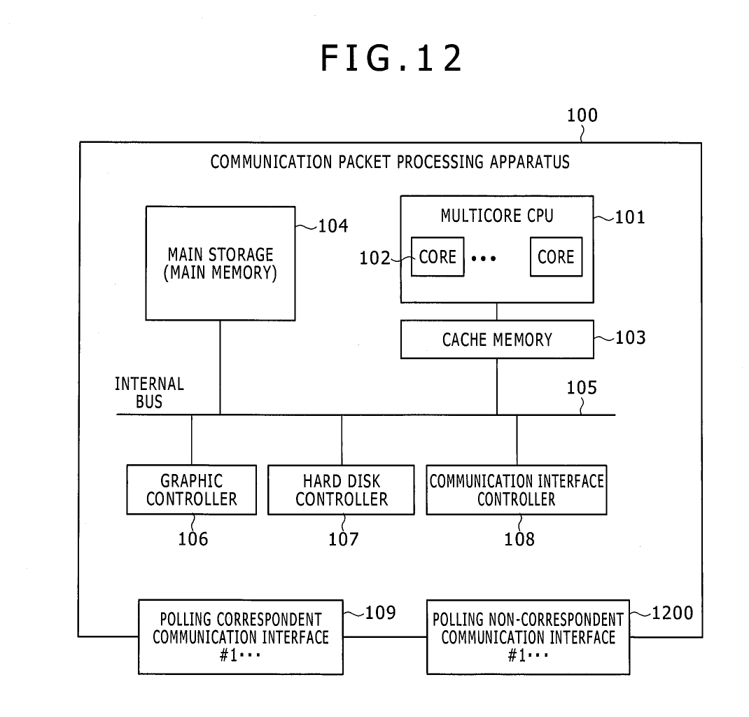

FIG. 12 shows hardware configuration of a communication packet processing apparatus according to one embodiment of the present invention.

The component, having the same function as that explained already in the communication packet processing apparatus of FIG. 1, is denoted by the same reference character as that, and the description thereof is omitted.

It is assumed that the communication packet processing apparatus 100 shown in FIG. 12 is provided with the communication interfaces 1200 not corresponding to the polling system, in addition to those 109 corresponding thereto. Besides, it is also assumed that the communication packet processing apparatus is equipped with a redundant function between those communication interfaces with the different communication packet reception methods.

For example, supposing that the communication packet processing apparatus 100 has two groups of the communication interfaces, one is an active group of the communication interfaces 109 corresponding to the polling system, the other is a stand-by group of the communication interfaces 1200 not corresponding thereto. Then, it is possible to switch the communication interface from the active group to the stand-by group.

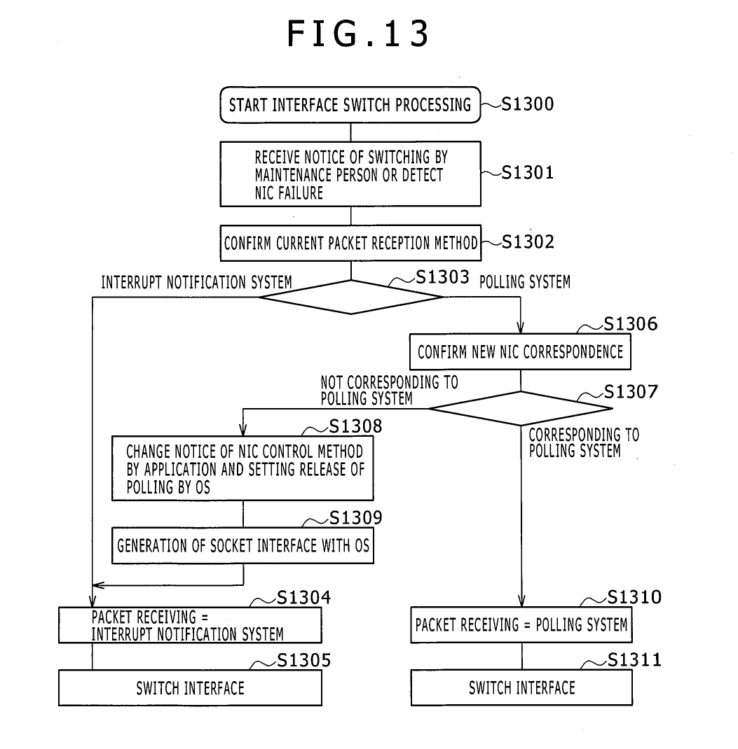

Switching the communication interface for redundancy will be described with reference to FIG. 13.

FIG. 13 shows an example of a flowchart regarding communication interface switch processing for redundancy.

If the application 230 determines that switching of the communication interface 109 is necessary, based on a notice of switching by a maintenance person or detection of failure (S1301), it confirms the communication packet reception method under operation (S1302). As a result, if the method of the corresponding communication interface under operation is the interrupt notification system, the application 230 determines the method of the new communication interface as the interrupt notification system (S1304). Thereafter, the application 230 switches the communication interface 109 (S1305). After the switch of the communication interface (S1305), it is made possible to receive a packet by the new communication interface under the interrupt notification system.

As a result of the confirmation of the method (S1302), if the method of the corresponding communication interface under operation is the polling system, the application 230 performs a step of NIC correspondence confirmation of a new communication interface (S1306) in advance. The content of processing for NIC correspondence confirmation of the new communication interface (S1306) is the same as that described in FIG. 6. As a result of the NIC correspondence confirmation (S1306), if the operation of the new communication interface under the polling system is possible, the application 230 determines the packet reception method of the new communication interface as the polling system (S1310), and switches the communication interface (S1305). After the switch of the communication interface (S1305), it is made possible to receive a packet by the new communication interface under the polling system. As a result of the NIC correspondence confirmation (S1306), if the operation of the new communication interface under the polling system is impossible, the application 230 gives the OS 220 the notice to switch the packet reception method of the new communication interface from the polling system to the interrupt notification system (S1308). Subsequently, the application 230 generates the socket interface with the OS 220, and determines the method of the new communication interface as the interrupt notification system (S1304). Thereafter, the application 230 switches the communication interface (S1305). After the switch of the communication interface (S1305), it is made possible to receive a packet by the new communication interface under the interrupt notification system.

From the above, according to this embodiment, in a case where there coexist two methods of communication interfaces, one of which corresponds to the polling system and the other does not correspond thereto, it is possible to switch the communication interfaces among them during operation by the same software.

1. A communication packet processing apparatus for transmitting and receiving communication packets, comprising:
a communication interface for transmitting and receiving communication packets;
a communication interface control section for controlling the communication interface;
a communication packet control section for controlling transmission and reception of communication packets;
a first table storing hardware information and correspondent information of the communication interface, wherein the correspondent information includes a method of communication packet reception processing that the communication interface can correspond to; and
a parameter designating the method of communication packet reception processing to be performed by the communication packet processing apparatus,
wherein the method of the communication packet reception processing includes a first method and a second method,
wherein the communication interface operates under one or both of the first method and the second method, and
wherein the communication packet processing apparatus, when starting up, refers to the parameter and if the first method is designated, confirms whether the communication interface corresponds to the first method, and then if the result is affirmative, controls to enable the operation of the communication interface control section and the communication packet control section under the first method.

2. The communication packet processing apparatus according to claim 1, wherein, if the communication packet processing apparatus has a plurality of the communication interfaces, the communication packet processing apparatus confirms whether or not each of the communication interfaces corresponds to the first method by referring to the first table, then if all of the communication interfaces correspond to the first method, the communication packet processing apparatus controls to enable the operation of the communication interface control section and the communication packet control section under the first method.

3. The communication packet processing apparatus according to claim 1, wherein, if the communication interfaces do not correspond to the first method, the communication packet processing apparatus controls to enable the operation of the communication interface control section and the communication packet control section under the second method.

4. The communication packet processing apparatus according to claim 1, wherein, if the communication packet processing apparatus has not succeeded normally in performing the communication packet reception processing as a result of operation under the first method, the communication packet processing apparatus controls to enable the operation of the communication interface control section and the communication packet control section under the second method.

5. The communication packet processing apparatus according to claim 1, wherein the first table is configured to be read into the communication packet processing apparatus from the outside thereof when starting up the apparatus.

6. A communication packet processing method for transmitting and receiving communication packets in a communication packet processing apparatus, wherein the communication packet processing apparatus possesses a communication interface for transmitting and receiving communication packets and a first table storing correspondent information of the communication interface, the correspondent information including a method of communication packet reception processing that the communication interface can correspond to, the method of communication packet reception processing including a first method and a second method, the communication interface operating under one or both of the first method and the second method, and the communication packet processing method comprising:
referring to the first table if the first method is designated when starting up the communication packet processing apparatus to confirm whether the communication interface corresponds to the first method; and
operating under the first method if the result of confirming whether the communication interface corresponds to the first method is affirmative.

7. The communication packet processing method according to claim 6, further comprising when the communication packet processing apparatus has a plurality of the communication interfaces:
referring to the first table to confirm whether or not each of the communication interfaces corresponds to the first method; and
operating under the first method if all of the communication interfaces correspond to the first method.

8. The communication packet processing method according to claim 6, further comprising:
operating under the second method if the communication interfaces do not correspond to the first method.

9. The communication packet processing method according to claim 6, further comprising:
operating under the second method if operating under the first method has not succeeded normally in performing the communication packet reception processing as a result of operation under the first method.

10. The communication packet processing apparatus according to claim 2, wherein, if the communication interfaces do not correspond to the first method, the communication packet processing apparatus controls to enable the operation of the communication interface control section and the communication packet control section under the second method.

11. The communication packet processing apparatus according to claim 2, wherein, if the communication packet processing apparatus has not succeeded normally in performing the communication packet reception processing as a result of operation under the first method, the communication packet processing apparatus controls to enable the operation of the communication interface control section and the communication packet control section under the second method.

12. The communication packet processing apparatus according to claim 2, wherein the first table is configured to be read into the communication packet processing apparatus from the outside thereof when starting up the apparatus.

13. The communication packet processing method according to claim 7, further comprising:
operating under the second method if the communication interfaces do not correspond to the first method.

14. The communication packet processing method according to claim 7, further comprising:
operating under the second method if operating under the first method has not succeeded normally in performing the communication packet reception processing as a result of operation under the first method.
